(19) United States
(12) Patent Application Publication
(10) Pub. No.: US 2009/0180076 A1
(43) Pub. Date: Jul. 16, 2009

(54) PROJECTOR WITH SERVICE INFORMATION DISPLAYING FUNCTION AND SERVICE INFORMATION DISPLAYING METHOD FOR USE WITH SUCH PROJECTOR

(75) Inventors: Shao-Pen Lin, Hsinchu (TW); Ru-Mei Tsai, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: CORETRONIC CORPORATION, Hsinchu (TW)

(21) Appl. No.: 12/178,386

(22) Filed: Jul. 23, 2008

(30) Foreign Application Priority Data
Jan. 10, 2008 (TW) 097101060

(51) Int. Cl. G03B 21/26; G09G 5/00

(52) U.S. Cl. 353/25; 345/156

(57) ABSTRACT

A projector with a service information displaying function and a service information displaying method for use with the projector are provided. The projector includes a data storage unit, a monitor and a controller. The service information displaying method includes steps of pre-storing a data file in the projector, showing a main menu contained in the data file in response to a call request, and selecting a first item from the main menu and showing at least one service information corresponding to the first item.

### FIELD OF THE INVENTION

The present invention relates to a projector with a service information displaying function, and more particularly to a projector capable of displaying and searching service information during operation of the projector. The present invention also relates to a service information displaying method for use with the projector.

### BACKGROUND OF THE INVENTION

With rapid development of digitalized techniques, projectors become essential electronic appliances in many applications. For example, projectors can be used for making presentations, holding meetings or give lectures in classrooms, boardrooms or conference rooms. Recently, projectors can be used for viewing movies in home theaters or projecting images in home-use TV game consoles. For enhancing operating performance and fulfilling visual enjoyment, most projectors have large-sized screen for projecting images thereon.

Generally, projectors are operated with associated devices or hardware components such as desktop computers, notebook computers, document cameras projectors, DVD drives, TV game consoles, TV sets and the like. After the projectors are communicated with associated devices or hardware components, the signals or images outputted from these devices or hardware components can be projected on a screen for playback. FIG. 1 is a schematic functional block diagram illustrating an application of a projector 10. The projector 10 can be used in making a presentation in a meeting. When the projector 10 is communicated with a notebook computer 11, the presentation data file contained in the notebook computer 11 can be synchronously outputted and projected onto the projection screen 12 so as to directly display images of the presentation data file in real-time.

In addition to image output functions, the current projectors have sound output functions, reading and broadcasting functions for DVD disc, image-capturing and scanning function for actual specimens or the like. In other words, the current projectors usually have both functions of DVD drives and document cameras projectors. For diverse and convenient utility, the process of operating the projector should be more user-friendly and simplified in order for viewing movies in home theaters or making presentations in conference rooms for example. Typically, the projectors are usually classified into two types, i.e. tri-gun projectors and single gun projectors. Generally, the projection screens cooperating with these projectors are high quality projection screens. Alternatively, images can be projected onto planar walls of the conference rooms or other planes.

As previously described, the projectors have widespread and diverse functions and can be used in various instances and operated by users of different educated backgrounds. Due to diverse functions of the projectors, the complicated operating interfaces and functions become hindrance from using the projector when a same projector is used in different places (e.g. classrooms or conference rooms) or different projectors are used in the same place. In a case that the users are unfamiliar to operating procedures of the projectors or the projectors have breakdowns, the users may ask technicians or supervisors about proper operative procedures or possible trouble-shooting solutions. Alternatively, the users may look up an operation manual which is a print manual or a data file stored in an optical disc.

In practice, the users fail to immediately contact the technicians or supervisors to obtain proper operative procedures or possible trouble-shooting solutions. Moreover, since the operation manual and the projector are usually stored in separate places, the users may still fail to immediately look up the operation manual to obtain proper operative procedures or possible trouble-shooting solutions.

### SUMMARY OF THE INVENTION

The present invention provides a projector with a service information displaying function and a service information displaying method for use with the projector. In response to a call request inputted via the user interface, the service information can be read out and shown on the monitor to be searched or inquired. By means of such service information, the user can quickly contact the customer service stations or technical service centers to ask the customer service stations or technical service centers about proper operative procedures or possible trouble-shooting solutions.

In accordance with an embodiment of the present invention, there is provided a service information displaying method for use with a projector having a displaying function. The service information displaying method includes steps of pre-storing a data file in the projector, showing a main menu contained in the data file in response to a call request, and selecting a first item from the main menu and showing at least one service information corresponding to the first item.

In accordance with another embodiment of the present invention, there is provided a projector with a service information displaying function. The projector includes a data storage unit, a monitor and a controller. The data storage unit is used for storing a data file therein. The monitor is used for showing images. The controller is communicated with the data storage unit and the monitor for reading out a main menu of the data file from the data storage unit in response to a call request. The main menu is shown on the monitor. If a first item is selected from the main menu, at least one service information corresponding to the first item is shown on the monitor.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic functional block diagram illustrating an application of a projector 10;

FIG. 2 is a schematic functional block diagram illustrating a projector 20 with a service information displaying function according to a preferred embodiment of the present invention;

FIG. 3A is a flowchart illustrating a service information displaying method according to a first preferred embodiment of the present invention;

FIG. 3B is a schematic diagram of a main menu according to the first preferred embodiment of the present invention;

FIG. 4A is a flowchart illustrating a service information displaying method according to a second preferred embodiment of the present invention; and

FIG. 4B is a schematic diagram of a main menu according to the second preferred embodiment of the present invention.

### DETAILED DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive

FIG. 2 is a schematic functional block diagram illustrating a projector 20 with a service information displaying function according to a preferred embodiment of the present invention. As shown in FIG. 2, the projector 20 principally includes a data storage unit such as a read only memory (ROM) 22 in this diagram and the embodiment for storing a data file including service information. Alternatively, another exemplary data storage unit is a flash memory. The read only memory and the flash memory are non-volatile memories without the need of power to maintain the information stored therein. That is, even if the whole system is powered off or the power is interrupted, the stored information will be well retained and the same information can be used in the next time.

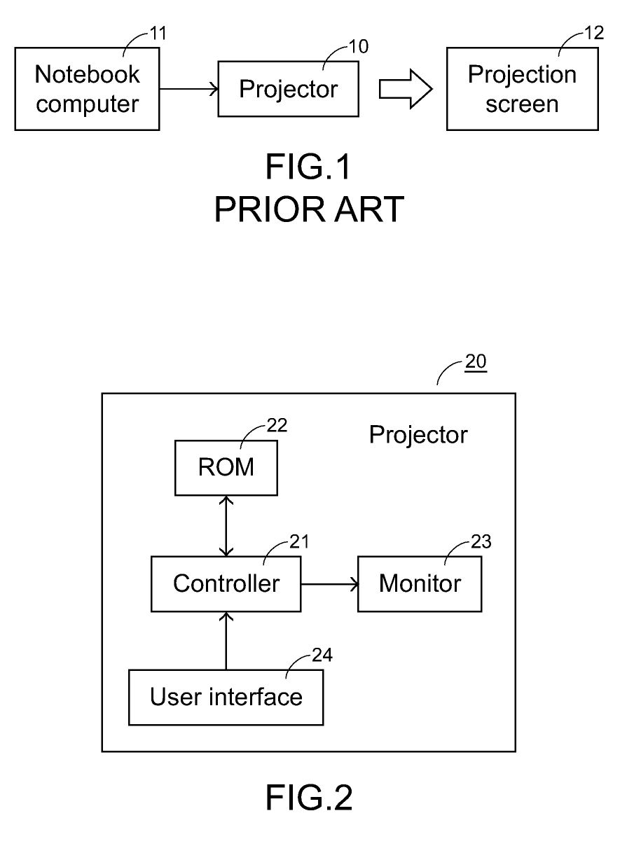

The projector 20 further includes a controller 21 and a monitor 23. The controller 21 is communicated with the read only memory 22 and the monitor 23. Likewise, the projectors 20 can be operated with associated devices or hardware components such as desktop computers, notebook computers, document cameras projectors, DVD drives, TV game consoles, TV sets and the like. After the projector 20 communicated with one of these devices or hardware components, the signals or images outputted from these devices or hardware components will be controlled or processed by the controller 21 and then displayed on the monitor 23. The principles of outputting and displaying images via the monitor 23 are similar to those of the conventional projector, and are not redundantly described herein. In an embodiment, the monitor 23 is a projecting unit for projecting images on a projection screen 12 as shown in FIG. 1.

The monitor 23 may also be a small-sized liquid crystal display installed in the projector 20 showing associated operating statuses, messages, texts or patterns for facilitating the users to monitor and realize the service information. In addition to the monitor 23, a projection screen (not shown in FIG. 2) is collocated.

Please refer to FIG. 2 again. The projector 20 further includes a user interface 24. Via the user interface 24, the user may input associated operating and controlling instructions. In an embodiment, the user interface 24 includes a plurality of operative keys arranged on a main body of the projector 20. Alternatively, the user interface 24 is a remote controller for remotely controlling execution of associated functions, wherein the remote controller has a plurality function keys to be triggered by the user. When the user interface 24 is communicated with the controller 21 through electrical connection or wireless connection, corresponding functions are executed according to the operating and controlling instructions inputted via the user interface 24.

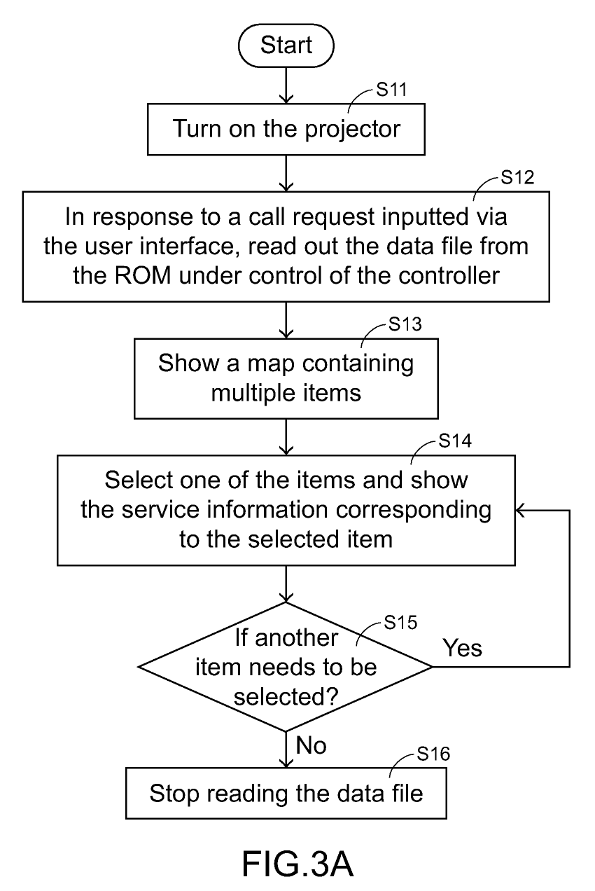

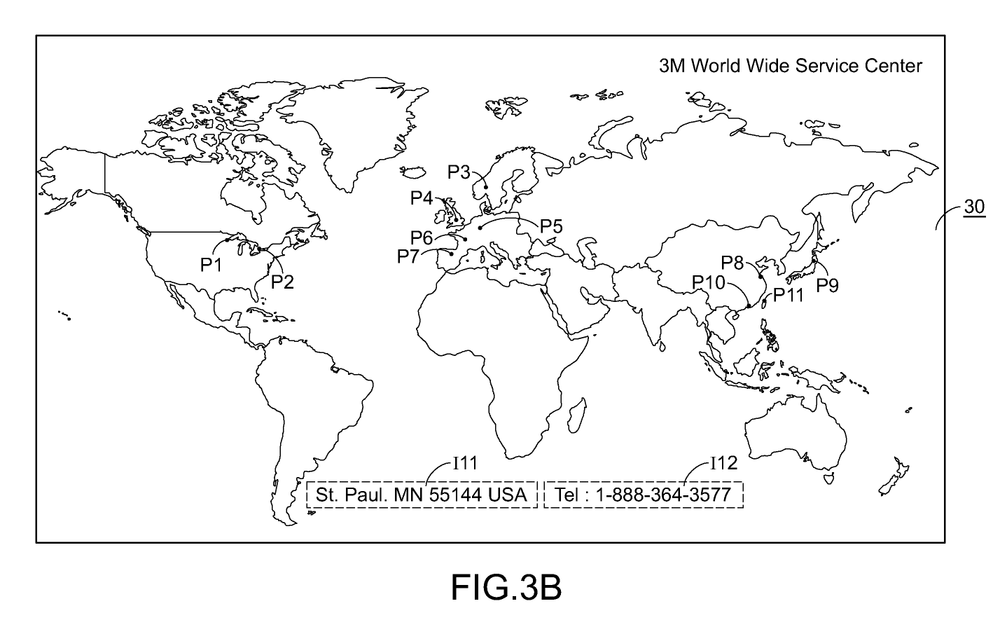

Hereinafter, a first preferred embodiment of executing a service information displaying function according to the present invention will be illustrated with reference to FIG. 3A, FIG. 3B and also FIG. 2.

FIG. 3A is a flowchart illustrating a service information displaying method according to the first preferred embodiment of the present invention. FIG. 3B is a schematic diagram of a main menu for executing the service information displaying function according to the first preferred embodiment of the present invention. As previously described, the read only memory 22 of the projector 20 has a pre-stored data file associated with service information such that the user may utilize and search the desired service information. First of all, the projector 20 is turned on (Step S11). In response to a call request inputted via the user interface 24, the data file stored in the read only memory 22 is read out under control of the controller 21 (Step S12). In this embodiment, one specified function key or function key set of the user interface 24 is triggered to input the call request so as to read out the data file. More especially, the data file includes a main menu, multiple items included in the main menu, and service information corresponding to the items.

After the data file is read out, the main menu including items are shown on the monitor 20 (Step S13). In an embodiment, the main menu can be shown as an on-screen display (OSD). As shown in FIG. 3B, the main menu is a map 30 pre-stored in the data file and automatically created with mapping software in response to the call request. Especially, the map 30 shows positions of countries and zones all over the world. More especially, the items indicate for example positions of the customer service stations or technical service centers provided by the companies or manufacturers of the projector 20 in these countries and zones. As shown in FIG. 3B, in response to the call request, the map 30 and the items P1˜P11 indicating positions of the customer service stations or technical service centers are shown on the monitor 20 under control of the controller 21.

In accordance with a key feature of the present invention, the map 30 is designed as an interactive information option. The up/down/left/right arrow keys of the user interface 24 can be selectively manipulated to lock one of the items P1˜P11 shown on the map 30. When one of the items P1˜P11 is selected, the service information indicating positions of the customer service stations or technical service centers in the countries and zones corresponding to the selected item will be shown (Step S14). In this embodiment, the service information includes the addresses and the telephone numbers of the customer service stations or technical service centers. By means of such service information, the user can quickly contact the customer service stations or technical service centers to ask the customer service stations or technical service centers about proper operative procedures or possible trouble-shooting solutions.

For facilitating the user to quickly realize the service information when operating the projector 20, the up/down/left/right arrow keys of the user interface or operative interface of the projector 20 can be interacted with the interactive information option and the map 30 according to a specified software design. For example, the selected item can be labeled in a specified color (e.g. red color) and the remaindering items are labeled in another color (e.g. blue color) such that the selected item is distinguishable.

For example, for inquiring the service information associated with a first item P1, the red-marked selective point needs to be moved to the first item P1 such that a first address I11 and a first telephone number I12 corresponding to the first item P1 are shown. If another item (e.g. a second item P2) needs to be selected, the user may trigger the arrow keys to move the red-marked selective point from the first item P1 to the second item P2 such that the address and the first telephone number corresponding to the second item P2 are shown (Step S15). Otherwise, if the service information corresponding to the selected item is sufficient, the specified function key or function key set of the user interface 24 can be triggered again to stop reading the data file and escape from the main menu (Step S16).

It is noted that, however, those skilled in the art will readily observe that numerous modifications and alterations may be made while retaining the teachings of the invention. For example, a preset item is selected when the map 30 is shown. Next, the user may operate the arrow keys to move the selective point from the preset item to another selected item. Moreover, the selective point is a circular dot with glisten such that the user may clearly identify the location of the selected item. For facilitating the user to clearly identify the service information, the service information (e.g. the address and the telephone number corresponding to the selected item) is preferably shown in the vicinity of the lower edge of the selected item. Alternatively, the service information can be shown as an image block in any location of the map 30.

In the above first preferred embodiment, the main menu is shown as an interactive map for facilitating the user to inquire the service information. Since the dimension of the map is relatively large and the memory of the projector 20 has limited storage capacity, only several representative positions of the customer service stations or technical service centers provided by the companies or manufacturers of the projector 20 are shown on the map 30. Hereinafter, in a second preferred embodiment, the main menu is expressed as an information table with the service information users needed displaying in it.

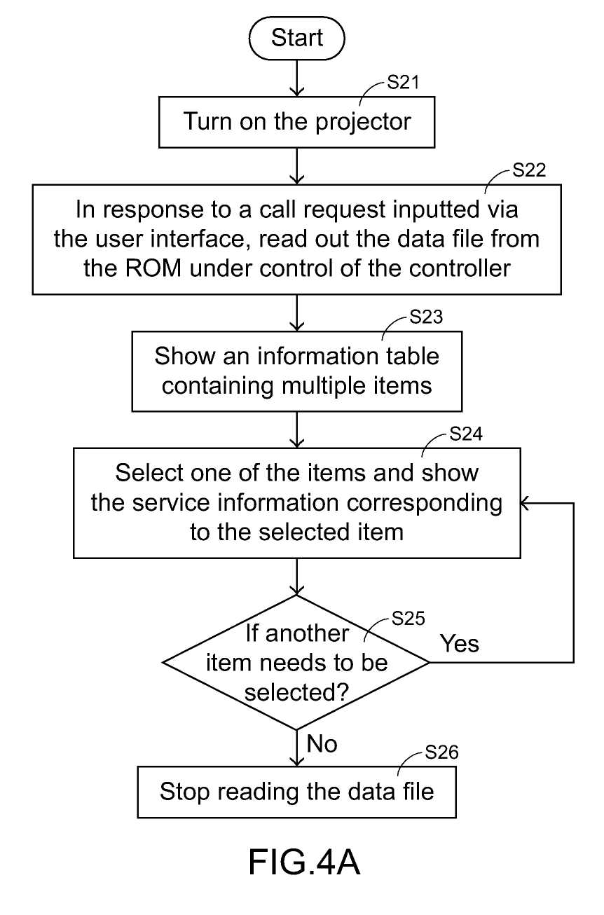

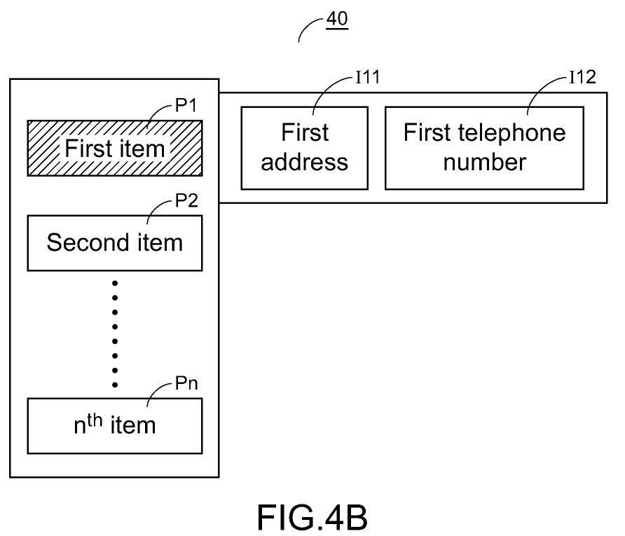

In a second preferred embodiment, please refer to FIG. 4A and FIG. 4B. FIG. 4A is a flowchart illustrating a service information displaying method according to the second preferred embodiment of the present invention. FIG. 4B is a schematic diagram of a main menu according to the second preferred embodiment of the present invention. The steps S21, S22, S24, S25 and S26 shown in the flowchart of FIG. 4A are respectively identical to the steps S11, S12, S14, S15 and S16 shown in the flowchart of FIG. 3A, and are not redundantly described herein. In the step S23, the main menu is an information table 40 in place of the map 30. The information table 40 contains several items P1˜Pn, which are classified according to place names, country names or zones and listed in a predetermined language. Likewise, the user may trigger the arrow keys of the user interface 24 to lock and select one of the items P1˜Pn such that the address and the first telephone number corresponding to the selected item are shown. For example, if the first item P1 is selected, a first address I11 and a first telephone number I12 corresponding to the first item P1 are shown.

Like the first preferred embodiment, the selected item can be labeled in a specified color and the remaindering items are labeled in another color such that the selected item is distinguishable. In contrast, all items contained in the main menu of this embodiment are expressed as an information table 40 in place of the map 30. Since the memory space required for storing the information table is largely reduced with respect to the map 30, the information table may contain more service information.

For facilitating identifying the items P1˜Pn of the information table 40, numerous modifications and alterations of the second preferred embodiment may be made while retaining the teachings of the invention. For example, the items P1˜Pn can be expressed in different languages such as Chinese, English, Japanese, German and the like. That is, after an item complying with a specified language or a specified family of languages is selected, the sub-items containing associated customer service stations or technical service centers under the specified language or the specified family of languages will be shown. By selecting a proper sub-item, the service information including for example the address and the telephone number corresponding to the selected sub-item will be shown.

In the above embodiments, the data file can be updated such that the newest service information to be inquired is obtainable. In other words, the data files stored in the read only memory 22 of the projector 20 can be updated via firmware update manner. In this embodiment, under control of the controller 21, the data files stored in the read only memory 22 are updated such that the old data files are replaced with new ones. In a case that the projector can be linked to the Internet, the newest service information data file can be downloaded through the Internet. In another case that the projector has a specified transmission interface (e.g. a USB interface or a SD interface), the storage medium having such transmission interface can be connected to the projector and thus the newest service information data file can be downloaded through such transmission interface. Alternatively, if the projector has an optical disc reading device, the optical disc with the newest service information data file can be loaded into the optical disc reading device to replace the old data file with a new one.

From the above description, in response to a call request inputted via the user interface, the service information can be read out and shown on the monitor to be searched or inquired. By means of such service information, the user can quickly contact the customer service stations or technical service centers to ask the customer service stations or technical service centers about proper operative procedures or possible trouble-shooting solutions. Therefore, the drawbacks encountered from the prior art will be effectively obviated. Regardless of viewing movies in home theaters or making presentations in conference rooms, the projector of the present invention can help the user to quickly ask the customer service stations or technical service centers about proper operative procedures or possible trouble-shooting solutions. Therefore, the present invention can obviate the drawbacks encountered from the prior art and achieve the objects of the present invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A service information displaying method for use with a projector having a displaying function, comprising steps of:
pre-storing a data file in the projector;
showing a main menu contained in the data file in response to a call request; and
selecting a first item from the main menu and showing at least one service information corresponding to the first item.

2. The service information displaying method according to claim 1, wherein the call request is generated by operating a user interface.

3. The service information displaying method according to claim 2, wherein the first item of the main menu is selected by operating the user interface.

4. The service information displaying method according to claim 2, further comprising steps of:
selecting a second item from the main menu by operating the user interface; and
showing at least one service information corresponding to the second item.

5. The service information displaying method according to claim 4, wherein the main menu comprises a map and the first and second items are included in the map.

6. The service information displaying method according to claim 4, wherein the main menu comprises an information table and the first and second items are included in the information table.

7. The service information displaying method according to claim 4, wherein the service information corresponding to the second item includes a second address and a second telephone number.

8. The service information displaying method according to claim 1, wherein the service information corresponding to the first item includes a first address and a first telephone number.

9. A projector with a service information displaying function, the projector comprising:
a data storage unit for storing a data file therein;
a monitor for showing images; and
a controller communicated with the data storage unit and the monitor for reading out a main menu of the data file from the data storage unit in response to a call request, wherein the main menu is shown on the monitor, and if a first item is selected from the main menu, at least one service information corresponding to the first item is shown on the monitor.

10. The projector with a service information displaying function according to claim 9, wherein the data storage unit is a read only memory or a flash memory.

11. The projector with a service information displaying function according to claim 9, wherein the projector further comprises a user interface, which is communicated with the controller, for generating the call request by operating the user interface

12. The projector with a service information displaying function according to claim 11, wherein the first item of the main menu is selected by operating the user interface.

13. The projector with a service information displaying function according to claim 11, wherein a second item is selected from the main menu by operating the user interface and at least one service information corresponding to the second item is shown on the monitor under control of the controller.

14. The projector with a service information displaying function according to claim 13, wherein the main menu comprises a map and the first and second items are included in the map.

15. The projector with a service information displaying function according to claim 13, wherein the main menu comprises an information table and the first and second items are included in the information table.

16. The projector with a service information displaying function according to claim 13, wherein the service information corresponding to the second item includes a second address and a second telephone number.

17. The projector with a service information displaying function according to claim 9, wherein the service information corresponding to the first item includes a first address and a first telephone number.

18. The projector with a service information displaying function according to claim 9, wherein the data file stored in the data storage unit is updated under control of the controller.
